(19) United States
(12) Patent Application Publication
(10) Pub. No.: US 2025/0229652 A1
(43) Pub. Date: Jul. 17, 2025

(54) INDUCTION CHARGING DEVICE

(71) Applicant: MAHLE International GmbH, Stuttgart (DE)

(72) Inventors: Thomas Himmer, Reichenbach (DE); Stefan Hirsch, Stuttgart (DE); Timo Laemmle, Kernen (DE); Holger Schroth, Maulbronn (DE); Martin Steinbach, Waiblingen (DE)

(21) Appl. No.: 18/854,517

(22) PCT Filed: Apr. 4, 2023
(86) PCT No.: PCT/EP2023/058851

§ 371 Date: Oct. 4, 2024

(30) Foreign Application Priority Data
Apr. 7, 2022 (DE) 10 2022 203 491.0

(51) Int. Cl. B60L 53/122; H01F 27/24; H01F 27/28; H02J 50/00; H02J 50/10; H02J 50/90

(52) U.S. Cl. CPC B60L 53/122; H01F 27/24; H01F 27/28; H02J 50/005; H02J 50/10; H02J 50/90

(57) ABSTRACT

An induction charging device for an inductive vehicle charging system for charging a battery of a battery-powered electric vehicle is disclosed. The induction charging device includes at least one coil for generating an electromagnetic alternating field and a coil carrier structure composed of plastic for positioning the strands. A supporting structure is arranged below the at least one coil in a vertical direction. The supporting structure has a plurality of supporting elements arranged at a distance from one another in a longitudinal direction perpendicular to the vertical direction and supported in the vertical direction on the coil carrier structure. At least two magnetic field conducting core plates composed of a soft magnetic material for conducting magnetic flux are provided and have at least one unground surface section. The core plates are supported in the vertical direction on at least one supporting element.

### CROSS-REFERENCE TO RELATED APPLICATIONS

This application claims priority to International Application No. PCT/EP2023/058851 filed on Apr. 4, 2023, which also claims priority to German Application DE 10 2022 203 491.0 filed on Apr. 7, 2022, the contents of each of which is hereby incorporated by reference in its entirety.

### TECHNICAL FIELD

The present invention relates to an induction charging device for an inductive vehicle charging system for charging a battery of a battery-powered electric vehicle. The invention also relates to an inductive vehicle charging system equipped with such an induction charging device.

### BACKGROUND

A conventional inductive vehicle charging system comprises a stationary induction charging device, which may also be referred to as a “floor assembly” and is usually arranged in a fixed location, for example at a vehicle parking space, and is connected to an electrical power supply, and a mobile induction charging device—which may also be referred to as a “vehicle assembly”—arranged on the respective vehicle, in particular on the vehicle underbody. The mobile induction charging device is in this case appropriately coupled to the battery of the vehicle, e.g. via a corresponding charger on the vehicle. To charge the battery, the vehicle is positioned with its mobile induction charging device with respect to the stationary induction charging device in such a way that electrical energy can be transferred from the stationary induction charging device to the mobile induction charging device by means of induction, i.e. via an electromagnetic alternating field. With the inductive vehicle charging system, charging plugs that have to be plugged in with vehicle-side charging sockets are not required.

An induction charging device has at least one coil that can generate an electromagnetic alternating field. Such a coil may also be referred to as an “induction coil” or a “resonator coil”. Furthermore, the stationary induction charging device can be equipped with several magnetic field-conducting core plates made of a soft magnetic material, which are arranged below the strands with respect to the horizontal direction. With the help of the core plates, the electromagnetic alternating field generated by the respective coil, which is also radiated downwards by the respective coil, is deflected upwards, thereby quasi-amplifying the alternating field radiated upwards.

For high electrical efficiency, it is necessary to arrange the core plates as close as possible to the strands, but also to position said core plates precisely relative to said strands in order to minimize or—ideally—avoid any negative influence on the resonance of the oscillating circuit formed by the coil. It is known to finish conventional core plates, which are typically parallelepipedal in shape and thus each have six (sur)faces, namely two opposing end faces and four peripheral faces arranged between the two end faces, by a mechanical process of precision grinding to achieve a high degree of dimensional accuracy and high surface accuracy. This is particularly necessary because the core plate is usually produced in a sintering process in which the volume of the core plate shrinks by 20-30%. This shrinkage typically occurs unevenly, creating tolerances in the range of 1.0% to 5.0%, which also cause major irregularities in the surface finish of the core plate. The aforementioned precision grinding of the surface thus counteracts unwanted tolerances.

However, the process of precision grinding is expensive and often exceeds the remaining manufacturing costs of the core plate.

The present invention is concerned with solving this problem. In particular, an improved version of an induction charging device is to be created that is characterized by high mechanical stability and improved inductive efficiency while also reducing manufacturing costs.

According to the invention, this problem is solved by the subject-matter of the independent claim(s). Advantageous embodiments are the subject of the dependent claims.

### SUMMARY

The basic idea of the invention is therefore to arrange the core plates of an induction charging device in terms of a vertical direction between the strands of the coil and a supporting structure and to provide at least one of the core plates with an unground, that is, not precision-ground, surface zone. The supporting structure, on which both the strand carrier with the strand and the core plate are supported, is preferably designed in such a way that the core plate, despite the at least one unground, i.e. original-shaped, surface contour, is inserted as plane-parallel as possible, preferably exactly plane-parallel to the alignment of the strand carrier. This ensures that the variance of the coil's inductive properties, which depends on the position of the core plates relative to the coil's strands, is kept small and thus the resonance of the circuit formed by the coil is influenced as little as possible—preferably not at all—in a negative way.

The supporting structure ensures that the induction charging device can be driven over by a vehicle without causing any deformation and the associated damage or even destruction of the coil carrier structure, the core plates, or the strands themselves. The solution presented here allows the core plates of the induction charging device to be supported by the supporting structure. This allows the high rigidity and, in particular, the compressive strength of the core plates to be used to transfer the forces acting on the surface of the coil carrier structure to the supporting structures.

Furthermore, by embedding the strands of the coil in a coil carrier structure, the strands are positioned with a low tolerance. This further increases the electrical efficiency of the induction charging device. Similarly, the core plates can be aligned with low tolerance and thus precisely with respect to the coil carrier structure and thus also with respect to the strands of the coil, despite the unground surface zone, with the help of the supporting structure. This minimizes the variance in the coil's inductive properties, which depends on the position of the core plates relative to the coil's strands. Thus, compensating measures, in particular in the power electronics of the induction charging device, can be particularly small to ensure a resonant circuit, resulting in further cost advantages.

In detail, an induction charging device according to the invention comprises at least one coil for generating an electromagnetic alternating field. The coil is designed with electrical conductors in the form of strands. A strand, on the other hand, has several electrically conductive wires. The induction charging device can also have suitable power electronics for supplying power to the coil and for controlling the coil.

The induction charging device has a longitudinal direction, a transverse direction perpendicular to the longitudinal direction, and a vertical direction perpendicular to both the longitudinal and transverse directions. The relative locations “top”, “bottom”, “above” and “below” refer to the spatial orientation of the induction charging device during proper operation. Thus, the vertical direction is anti-parallel to the direction of gravity and a lower component is consequently located below an upper component in the direction of gravity. When an induction charging device is properly installed in a recessed or sunken position on or in a surface, the longitudinal and transverse directions extend horizontally, whereas the vertical direction extends in the vertical direction, i.e. anti-parallel to the direction of gravity. In the induction charging device, the coil extends preferably in a plane perpendicular to the vertical direction, which can be spanned by the longitudinal and transverse directions. In this context, “lateral” means “perpendicular to the vertical direction”. Accordingly, a “lateral plane” in the present case is a plane that extends perpendicular to the vertical direction.

The induction charging device according to the invention also comprises a coil carrier structure made of plastic for positioning the strands, in which the strands are at least partially embedded. In the present context, the term “embedded” is understood to mean that the embedded component, i.e. the strand(s), is more or less surrounded by the material of the structure in which the respective component is embedded. This can be achieved by providing suitable recesses or cutouts in the structure for the respective component to be inserted. It is also conceivable that the respective structure could be injection-molded or cast onto the respective component, or even glued on. The coil carrier structure is designed to be expediently flat and planar.

Furthermore, the induction charging device according to the invention comprises a supporting structure that has a plurality of supporting elements, each extending along the vertical direction, which are arranged at a distance from one another in the longitudinal direction perpendicular to the vertical direction and are supported in the vertical direction on the coil carrier structure. The supporting elements can be designed to be longitudinal in the vertical direction. At least one supporting element can be designed as a supporting column.

According to the invention, the induction charging device further comprises at least two, preferably several, magnetic field conducting core plates made of a soft magnetic material, which are arranged at a distance from each other, and which each extend along the longitudinal direction, wherein a core plate is supported on at least one supporting element.

The at least two core plates consist of a soft magnetic and preferably electrically insulating material and each have at least one unground surface section. Preferably, the support on the supporting structure is realized by means of the unground surface section. Soft magnetic materials such as ferrites are characterized by a low coercivity, which is expressed in a small coercive field strength. For the relative permeability μR, it is preferable that μ_{R}>2 and in particular that μ_{R}>1,000. Suitable materials include ferrites, for example, so that core plates made of ferrite can also be referred to as “ferrite plates”. The core plates are designed to be flat and planar.

The induction charging device according to the invention presented here can be used both as a stationary induction charging device and as a mobile induction charging device. In its proper operating state as a stationary induction charging device, the latter is installed on a vehicle parking area onto a floor surface or recessed, in particular sunk, into the floor surface. In proper operating condition as a mobile induction charging device, the latter is installed in a vehicle.

In a preferred embodiment, at least two, preferably several, particularly preferably all of the core plates, each have a parallelepipedal shape and each have two end faces extending perpendicular to the vertical direction and four peripheral faces that connect the two end faces to one another.

In this embodiment, at least one of the aforementioned faces has at least one unground face zone. This means that this unground face zone has not been surface-treated by a grinding process, in particular by precision grinding. Preferably, the at least one face zone forms more than 60%, particularly preferably more than 80%, of the respective face, i.e. one of the four peripheral faces or one of the two end faces. In this way, the manufacturing costs for the core plate formed in this way can be significantly reduced. If two or more of the existing core plates are designed in this way, the cost-saving effect is multiplied accordingly.

Preferably, the at least one face with the at least one unground face zone can be one of the four peripheral faces. Particularly preferred, all four peripheral faces may each have an unground face zone. Thus, the core plate can be attached to the supporting structure by means of the aforementioned unground face zone and thus positioned with high precision relative to it.

In another preferred embodiment, the at least one face with the at least one unground face zone can be one of the two end faces. In this embodiment, both end faces may be provided with at least one unground face zone. Since the end faces make up a larger area of the total surface of the cuboid than the peripheral sides, particularly large cost advantages can be achieved in this way.

According to a favorable further training at least one face can have two or more unground face zones, which are arranged at a distance from each other in each case. In this way, the cost-saving effect can be increased.

In another preferred embodiment, the induction charging device has a housing surrounding a housing interior. The housing consists of an upper and a lower part that face each other in the vertical direction. Preferably, the upper housing part can be part of a housing pot that is open at the bottom. In this case, the lower housing part can be designed as a housing cover to seal the housing pot. In this embodiment, the coil carrier structure, the core plates and the supporting structure are arranged in the housing interior. The supporting elements of the supporting structure are supported at the bottom on the lower housing part or the housing cover, whereas the coil carrier structure is supported at the top on the upper housing part or the housing pot, opposite the housing cover. The housing cover can be formed by a base plate of the induction charging device. The base plate or the housing cover can perform an electromagnetic shielding function. The material of the housing cover or base plate can be particularly useful for this purpose. In particular, the base plate or the housing cover can be designed as a metal shielding plate. In this case, the housing has electromagnetic shielding properties. The casing can be made of metal. The base plate or the housing cover can also be used to place the induction charging device on a surface. The lower housing part can therefore be used to place the induction charging device on a surface at or in the respective vehicle parking space. The supporting structures can transfer forces in the vertical direction from the upper housing part to the lower housing part via the coil carrier structure, which can occur, for example, when a vehicle drives over the induction charging device. Furthermore, it is conceivable to configure the supporting elements in a heat-conducting manner so that additional heat from the coil and/or the core plates can be conducted away from them. For this purpose, the supporting elements can be made of metal or a heat-conducting plastic.

According to a favorable further development of the induction charging device according to the invention, a holding-down element, which presses the coil carrier structure and the core plates against the supporting elements of the supporting structure, is arranged on the housing pot for each supporting element, in each case projecting into the housing interior. This can improve the stability of the structure.

In a preferred embodiment, a holding-down element and a supporting element lie opposite each other in the vertical direction, so that a core plate and the coil carrier structure are arranged between the coil carrier structure and the supporting structure. This ensures that the mechanical load path, starting from the holding-down element and running in the opposite direction to the vertical direction, always ends in a supporting element.

Particular preference is given to a coil carrier structure that is either sandwiched between the supporting structure and the upper housing part or sandwiched between the core plates and the upper housing part. In both variants, the coil carrier structure is held securely between the upper part of the housing and the supporting structure.

In another preferred embodiment, at least one core plate is supported on two adjacent supporting elements along the longitudinal direction. This allows the core plate to be held securely in the induction charging device and the coil carrier structure to be positioned in a stable manner.

According to a further advantageous further development, the core plates are arranged in the longitudinal direction at a distance from the adjacent supporting elements, thus forming a respective gap. The distance between two adjacent supporting elements measured in the longitudinal direction is therefore greater than the nominal length of the core plates in the longitudinal direction. This also allows the use of core plates with relatively high component tolerance, i.e. core plates with non-precision-ground, i.e. original-shaped, peripheral faces.

Preferably, a holding-down element and a supporting element can be located opposite each other along the vertical direction, so that a core plate and the coil carrier structure are sandwiched between the coil carrier structure and the supporting structure. This measure also improves the precise and stable positioning of the core plates in relation to the coil carrier structure. The mechanical stability of the induction charging device is also increased.

In particular, a step forming a bearing face can be formed on the adjacent supporting elements, on which a respective core plate rests for support in the vertical direction. Thus, the core plates can be held firmly to the supporting structure by utilizing the force of gravity created by the core plates' dead weight.

The core plate may be particularly preferably arranged along the vertical direction on the bearing face of the respective supporting element. Since the respective core plate rests on the bearing face along the direction of gravity, this facilitates a mechanically stable fixation and positioning of the core plate on the respective supporting element.

According to another advantageous further development, at least one core plate and preferably all core plates are each attached to the respective bearing face by means of one, at least two, preferably by means of at least three, particularly preferably exactly three, adhesive bonds. A suitable adhesive can be used to form the bonded joint. In this way, a permanently stable fixation and positioning of the core plates relative to the supporting structure and also to the coil carrier structure with the coil can be achieved. The adhesive bond can preferably extend between 2 mm and 200 mm in the longitudinal direction. An adhesive bond designed in this way is technically particularly easy to implement, which simplifies the production of the induction charging device. In addition, a variable adhesive thickness at the adhesive joints can be used to ensure that a high positional accuracy of the core plate in relation to the strand carrier can be achieved even when bonding to an unground and thus inaccurate surface zone, which is particularly sufficient to ensure that the variance of the inductive properties of the coil, which depends on the position of the core plates relative to the strands of the coil, can be kept small and thus the resonance of the oscillating circuit formed by means of the coil can be negatively influenced as little as possible—preferably not at all.

According to another advantageous further development, a positioning contour with at least one positioning element is formed on each of the end faces of the core plates facing away from the coil carrier structure. In this further development, a complementary counter-positioning element is formed on one of the bearing faces for each positioning element, for the purpose of laterally positioning the core plates relative to the supporting structure. This allows the core plates to be positioned laterally with great precision relative to the supporting structure.

The positioning elements are particularly useful due to the—preferably milled—recesses provided on the end face. In this variant, the majority of the core plate end face facing away from the coil carrier structure can be left unground, and only the preferably small surface areas of the milled recesses need to be ground, in particular precision-ground, with high precision. This significantly reduces the effort required for precision grinding such a core plate with milled recesses. In this variant, the recesses are preferably arranged on an outer rim section of the respective end face. At least one recess in the edge of the core plate that forms the outer boundary of the rim section can be designed to be open. In principle, the recesses can have any contour or geometric shape. In particular, a round, especially circular, or angular contour may be considered, in particular the contour of a polygon.

In a particularly preferred embodiment, at least one core plate is supported on exactly one supporting element, preferably on an upper side of the supporting element facing the coil carrier structure. Preferably, this can apply to all core plates of the induction charging device. Load transfer from the upper to the lower housing part along the vertical direction thus occurs exclusively via the associated supporting element. This leads to a reduced bending stress on the core plates and thus to a particularly significant reduction in the risk of damage and/or breakage of the at least one core plate. It is therefore particularly preferable for the respective supporting element to be centered in relation to the core plate, in particular in relation to the end face of the core plate facing the supporting element.

According to a further advantageous development, a recess is formed on an end face of at least one core plate, preferably of all core plates, which faces the upper side of the supporting element. The recess can be created by milling. In said recess, the associated supporting element is partially accommodated in this further embodiment, so that a recess floor rests on the upper side of the supporting element. With the help of such a recess, the lateral positioning accuracy, by means of which the core plate is positioned perpendicular to the vertical direction relative to the other components of the induction charging device, can be further improved. This also optimizes the magnetic flux guidance achieved by means of the core plate. Furthermore, in this variant, the majority of the core plate's end face that is turned away from the coil carrier structure and thus turned towards the supporting element can be left in an original-shaped state, and only the preferably small surface area of the milled recesses needs to be post-processed with high precision. This significantly reduces the amount of work involved in post-processing a core plate with a central milled recess.

In particular, a positioning body, preferably made of plastic, can be applied, in particular glued, to the end face of at least one core plate facing the supporting structure, which positioning body engages in a cutout arranged on the upper side of the respective supporting element, in particular without touching the supporting element in the vertical direction. The interaction between the positioning body and the cutout supports a particularly precise lateral positioning of the core plate relative to the supporting element and thus to the other components of the induction charging device. Since the positioning bodies are arranged in different vertical directions in relation to the respective supporting element, it is also ensured that the mechanical load path from the core plate to the supporting element consists exclusively of the direct contact face between the core plate and the supporting element and that the positioning body or the positioning element remains load-free during assembly.

In a preferred embodiment, the supporting elements are attached to a base plate extending in the longitudinal direction, which is arranged below the supporting structure in the vertical direction. The base plate in question may be formed by the housing cover of the induction charging device. This allows the supporting elements of the supporting structure to be securely attached to the housing and precisely aligned with the coil carrier structure, which is preferably attached to the housing pot.

When operated at high electrical power, the coil can generate a comparatively large amount of heat, which must be dissipated, in particular to protect the power electronics of the induction charging device. According to another advantageous further embodiment, an adapter plate can therefore be arranged between the coil carrier structure and the supporting structure with respect to the vertical direction, which adapter plate rests with an upper side flat against the coil carrier structure. The adapter plate extends in the longitudinal direction and can be made of a material with a higher thermal conductivity than the plastic of the coil carrier structure. It may also be appropriate to provide that the adapter plate is in direct contact with the strands on its upper side and/or is in direct contact with the core plates on its underside. This can improve heat transfer between the adapter plate and the strands and/or core plates. The material of the adapter plate is electromagnetically neutral, i.e. electrically insulating and magnetically permeable. As already mentioned, the material of the adapter plate is preferably a relatively good heat conductor, wherein in particular, for its heat conductivity λ, it can be assumed that λ>0.5 Watt/m·K. The material of the adapter plate can be, in particular, a heat-conducting plastic, a ceramic or a mixture of both materials.

Particularly preferably, a recess can be formed on the end face of each core plate facing the coil carrier structure, in which recess a complementarily formed extension, which projects from the coil carrier structure or from the adapter plate, engages, preferably in an interlocking manner. Additional, separate position securing is not required with this design variant since the core plate is held in a positionally stable manner in the sandwich of the two counter-contours that fill the contour error, which is formed by the recess provided on the supporting element and the extension formed on the adapter plate.

In another preferred embodiment, a thermal filling material is arranged on an upper side of the coil carrier structure facing away from the core plates. This improves the dissipation of the waste heat generated in the coil during operation of the induction charging device, thereby cooling the coil.

It is preferable for the thermal filling material to be in direct contact with the electronics and/or the base plate. This leads to a further increase in heat transfer between the electronics and the base plate.

According to a favorable further embodiment, a thermal filling material is arranged on the cover side facing the coil carrier structure of at least one core plate, which thermal filling material preferably contacts the coil carrier structure mechanically. Alternatively or additionally, said thermal filling material can be arranged on the cover side of at least one core plate, which cover side faces away from the coil carrier structure. This improves heat dissipation from the coil and cools the coil.

In particular, said thermal filling material can be arranged on at least one, preferably on all, of the four peripheral faces of at least one core plate.

The thermal filling material can be formed in all the above-mentioned embodiments by thermally conductive fillers or adhesives, which can in particular equalize or fill existing gaps, voids and the like. This is particularly advantageous for thermally bonding irregular surface contours, such as those left on molded surfaces, to flat surfaces, thus enabling conductive heat dissipation.

The invention also relates to an inductive vehicle charging system according to the invention, with an induction charging device according to the invention, as explained above. The advantages of the induction charging device according to the invention are therefore transferred to the vehicle charging system according to the invention. The inductive vehicle charging system according to the invention is used to charge a battery of a battery-powered electric vehicle. For this purpose, the vehicle charging system has a stationary induction charging device of the type described above and a mobile induction charging device arranged in or on the vehicle. It is clear that the vehicle's mobile induction charging device is synchronized with the stationary induction charging device, so that when the vehicle or the mobile induction charging device is properly positioned above the stationary induction charging device, inductive energy transfer can take place to charge the battery.

Other important features and advantages of the invention can be seen from the dependent claims, from the drawings and from the associated description of the figure based on the drawings.

It is understood that the above-mentioned features and those yet to be explained below can be used not only in the combination indicated in each case, but also in other combinations or on their own, without deviating from the scope of the invention. The above-mentioned components of a superordinate unit, such as a device, an apparatus, or an arrangement, which are designated separately, can form separate parts or components of this unit or be integral areas or sections of this unit, even if this is shown differently in the drawings.

Preferred exemplary embodiments of the invention are shown in the drawings by way of example and will be explained in more detail in the following description, wherein identical reference numbers refer to identical or similar or functionally identical elements.

### BRIEF DESCRIPTION OF THE DRAWINGS

The drawings, each schematically, show in

FIGS. 1 through 9 respectively, a highly simplified, basic vertical section through a part of a stationary induction charging device in different embodiments,

FIG. 10 a diagram showing the lateral arrangement of the recess on the cover side of the core plate and the relative position of the associated holding-down element.

### DETAILED DESCRIPTION

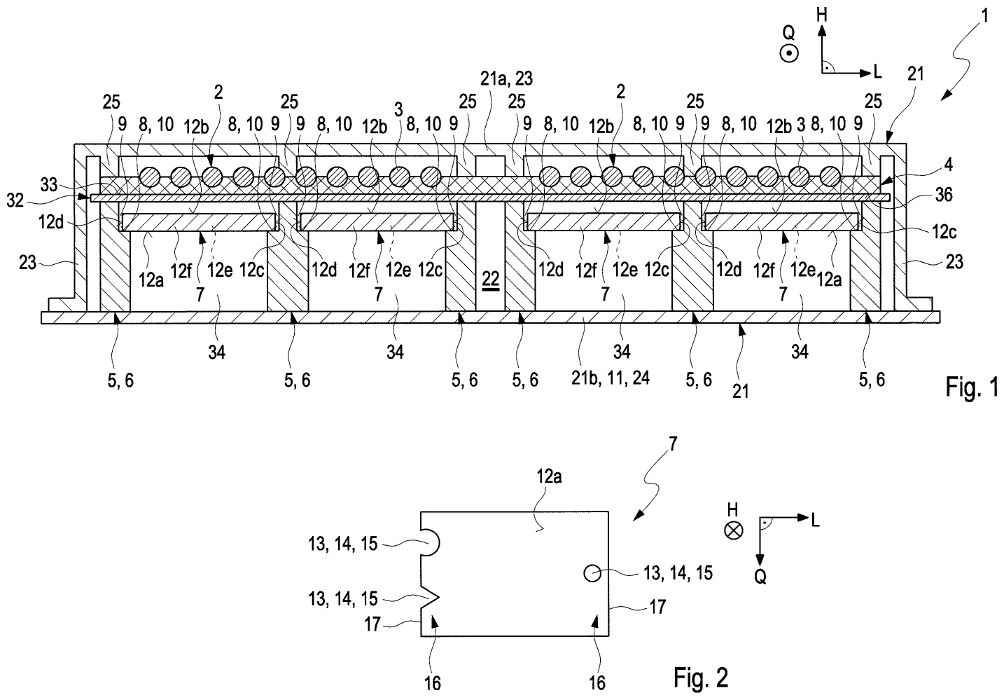

According to FIGS. 1 through 10, a stationary induction charging device 1 according to the invention comprises at least one coil 2 for generating an electromagnetic alternating field.

The induction charging device 1 is part of an inductive vehicle charging system which, in addition to the stationary induction charging device 1 shown, has a mobile induction charging device arranged on or in a battery-powered electric vehicle and is not shown here. The stationary induction charging device described below can also be used as a mobile induction charging device. The vehicle charging system is used to charge the battery of a battery-powered electric vehicle, wherein the electrical energy is transmitted by means of induction, eliminating the need for plug connections between a charging station and the vehicle.

The stationary induction charging device 1 has a longitudinal direction L, a transverse direction Q running perpendicular to the latter, and a vertical direction H running perpendicular to the longitudinal direction L and the transverse direction Q.

Thus, the vertical direction H is anti-parallel to the direction of gravity and a lower component is then located in the vertical direction H below an upper component. When a stationary induction charging device 1 is properly installed on a floor surface or recessed into the floor surface, the longitudinal direction L and the transverse direction Q extend horizontally, whereas the vertical direction H extends vertically.

In the stationary induction charging device 1, the coil 2 extends in a lateral plane perpendicular to the vertical direction H, which can extend parallel to a base plane spanned by the longitudinal direction L and the transverse direction Q. Coil 2 is designed with electrical conductors in the form of strands 3. The induction charging device 1 also includes a coil carrier structure 4 made of plastic, in which the strands 3 are at least partially embedded and which is used to position the strands 3. Furthermore, the induction charging device 1 according to FIGS. 1 through 9 comprises a supporting structure 5 that has several supporting elements 6, each of which extends along the vertical direction H. The supporting elements 6 are arranged at intervals along the longitudinal direction L. The supporting elements 6 are supported in the vertical direction H on the coil carrier structure 4. Furthermore, the induction charging device 1 comprises a plurality of core plates 7, each made of a soft magnetic material, which are arranged in a row at a distance from one another along the longitudinal direction L.

The induction charging device 1 has a housing 21 in all the examples shown, which housing 21 surrounds a housing interior 22. In the example scenario, the housing 21 has an upper and a lower housing part 21a, 21b, which are located opposite each other in the vertical direction H. In the example of the figures, the upper housing part 21a is part of the housing pot 23 of the housing 21, which housing pot 23 is open at the bottom in the vertical direction H. The lower housing part 21b is designed as a housing cover 24 for closing the housing pot 23. The housing cover 24 can be formed by a base plate 11 of the induction charging device 1, which base plate 11 delimits the induction charging device 1 in the vertical direction H at the bottom. The coil carrier structure 4, the core plates 7 and the supporting structure 5 are arranged in the housing interior 22 in all exemplary embodiments. The supporting structure 5 is supported on the housing cover 24, whereas the coil carrier structure 4 is supported on the housing pot 23, opposite the housing cover 24. An adapter plate 32 can be arranged between the coil carrier structure 4 and the supporting structure 5 with the supporting elements 6 with respect to the vertical direction H, which adapter plate 32 rests with an upper side 33 flat against an underside 36 of the coil carrier structure 4.

In the example scenario, the core plates 7 each have a parallelepipedal shape. In the vertical sections shown in FIGS. 1 through 9, the geometry of a rectangle thus results. Each of the core plates 7 has two end faces 12a, 12b extending perpendicular to the vertical direction H and four peripheral faces 12c, 12d, 12e, 12f, which connect the two end faces 12a, 12b to one another. At least one of the aforementioned faces 12a-12f has an unground face zone. This means that this unground face zone has not been surface-treated by a grinding process, in particular by precision grinding. Preferably, the at least one face zone forms more than 60%, particularly preferably more than 80%, of the respective face 12a-12f, i.e. one of the four peripheral faces 12a-12d or one of the two end faces 12a-12f.

A holding-down element 25, which projects into the housing interior 22, is arranged on the housing pot 23 for each supporting element 6 and presses the coil carrier structure 4 and the core plates 7 against the supporting elements 6 of the supporting structure 5, thereby improving the mechanical stability of the arrangement. It is useful for a holding-down element 25 and a supporting element 6 to lie opposite each other along the vertical direction H, so that a core plate 7 and the coil carrier structure 4 are arranged in a sandwich-like manner between the coil carrier structure 4 and the supporting structure 5.

In the example of FIG. 1, each core plate 7 is arranged in a space 34 formed between two adjacent supporting elements 6 along the longitudinal direction L. Each of the core plates 7 is supported by the two adjacent supporting elements 5 that border the respective intermediate space 34.

According to FIG. 1, a step 10 can be formed on each of the two supporting elements 6 adjacent to the respective core plate 7 in the longitudinal direction L, which step 10 forms a bearing face 8 on which the respective core plate 7 can rest for support in the vertical direction H. Furthermore, the core plates 7 can be arranged in the longitudinal direction L at a distance from the adjacent supporting elements 6, forming a respective gap 9. Preferably, the core plate 7 can rest on the bearing face 8 of the respective supporting element 6 in the vertical direction H. Each core plate 7 is bonded to the associated supporting element 6 with three adhesive joints (not shown). Other numbers of adhesive bonds are also conceivable in variants. Preferably, each of the adhesive bonds in the longitudinal direction L has an extension between 2 mm and 200 mm.

FIG. 2 shows the end face 12a of one of the core plates 7, facing away from the coil carrier structure 4 and towards the supporting elements 6, in a plan view along the vertical direction H (with the housing cover 24 removed). Accordingly, a positioning contour 13 with positioning elements 14 is formed on this end face 12a of the core plate 7. The positioning elements 14 can be formed by milled recesses 15 provided on the end face 12a. The recesses 15 are arranged as shown in FIG. 2 at an outer rim section 16 of the respective end face 12a. In particular, the recesses 15 can be open towards the edge 17 of the core plate 7 that delimits the outer edge of the rim section 16 (this is shown in FIG. 2 for the two left-hand positioning elements 14). For each positioning element 14, a complementary counter-positioning element (not shown) can be formed on the bearing faces 8 for the lateral positioning of the core plates 7 relative to the supporting structure 5. In the plan view shown, the positioning elements 14 and recesses 15 can, in principle, have any geometric shape. As shown, a polygonal, in particular triangular or round, in particular circular, geometry is conceivable. The geometry of a segment of a circle is also conceivable.

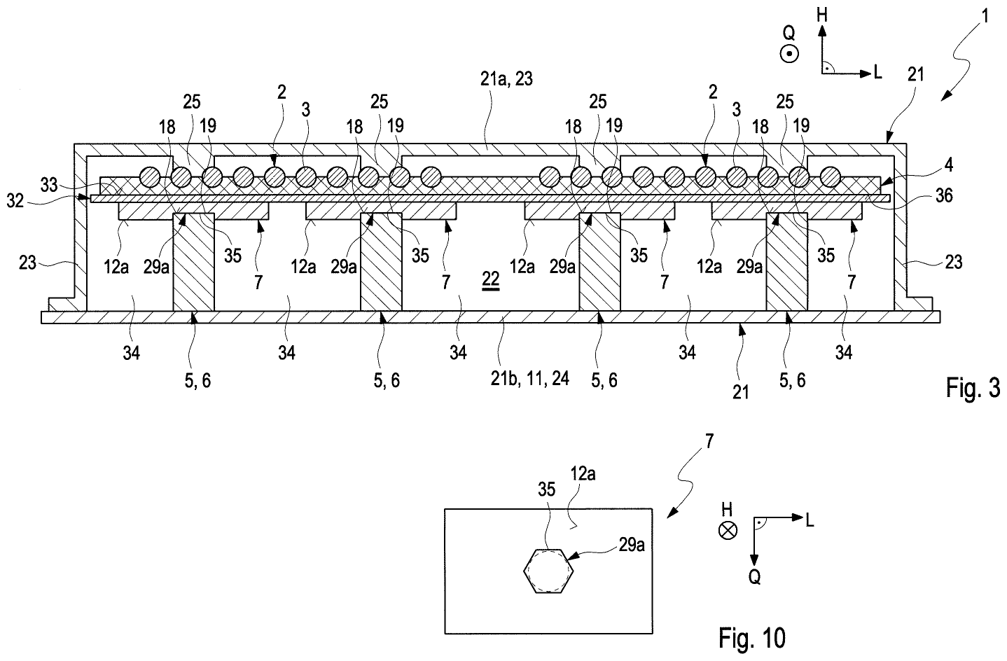

FIG. 3 shows a variant of the example in FIG. 1. In contrast to the example in FIG. 1, each of the core plates 7 is supported here on exactly one supporting element 6 and rests on an upper side 18 of the supporting element 6 that faces the coil carrier structure 4. It is advantageous to assign each core plate 7 exactly one supporting element 5, which is posi-tioned in the center of the respective core plate 7, as shown. This results in a particularly efficient force transfer. On one of the lower end faces 12a of the core plates 7 facing the upper side 18 of the supporting elements 6, respectively one lower recess 29a is formed, for example by milling, in which the supporting element 6 is partially accommodated so that a recess floor 19 of the lower recess 29a rests on the upper side 18 of the supporting element 6.

FIG. 10 shows a diagram illustrating the lateral arrangement of the lower recess 29a on the cover side 12a of the core plate 7 and the relative position of the associated holding-down element 25. Accordingly, the lower recess 29a can be arranged centered on the end face 12a as shown, wherein “centered” can refer to both the centroid and the gravimetric center of the core plate 7. The assigned holding-down element 25 is arranged, as shown in FIG. 3, at a distance from the core plate 7 in the vertical direction H, but is always arranged within the lower recess 29a, so that the force exerted by the holding-down element 25 can always be absorbed by the supporting element 6 arranged in the lower recess 29a via the core plate 7. Each supporting element 6 is followed by a holding-down element 25 along the vertical direction H on the respective core plate 7.

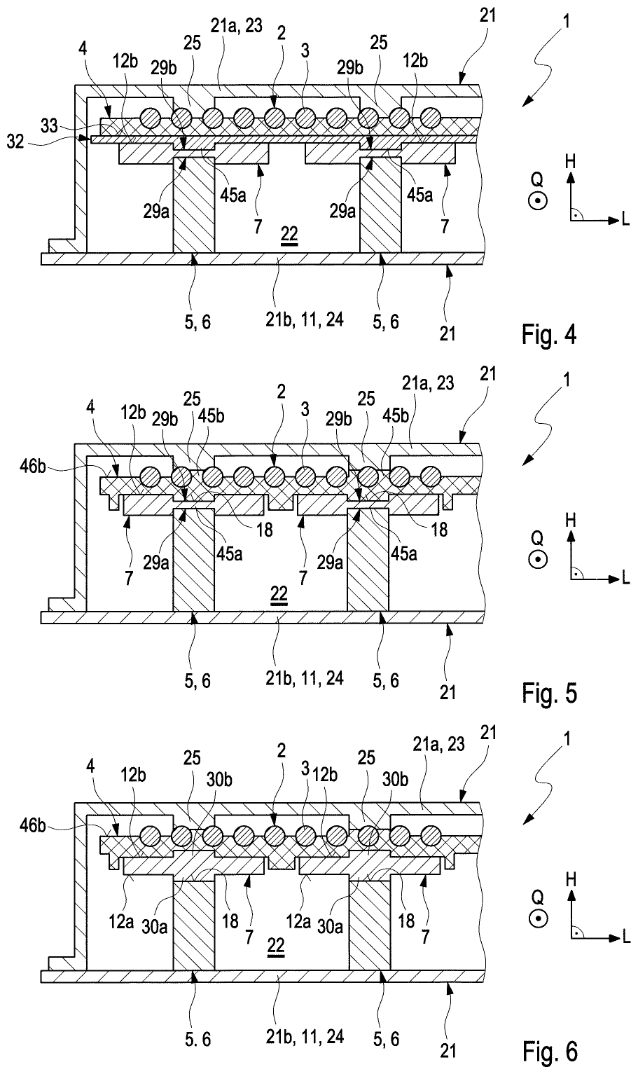

FIGS. 4 through 9 illustrate further developments of the example shown in FIG. 3, each showing a detailed representation of the induction charging device 1 in the area of one of the supporting elements 6 of the supporting structure 5.

In accordance with the further embodiment of FIG. 4, a respective upper recess 29b, produced by milling, can also be formed on the end face 12b of the core plates 7 facing the coil carrier structure 4. A lower extension 45a, which is of complementary design and projects in the opposite direction to the vertical direction H from the adapter plate 32, engages in this upper recess 29b. An extension 45a such as this can be provided for each core plate 7 on adapter plate 32 of the induction charging device 1. The upper recess 29b and the extension 45a can be used to precisely align the core plate 7 laterally opposite the coil carrier structure 4, thus optimizing the magnetic field guidance.

Preferably, the recesses 29a, 29b provided on the end face 12a or 12b lie opposite one another as shown in FIG. 4, i.e. the lower recess 29a provided on the end face 12a follows in a virtual extension opposite to the vertical direction H on the upper recess 29b provided on the end face 12b. Accordingly, in the example of FIG. 4, each holding-down element 25 is followed in the opposite direction to the vertical direction H by a lower extension 45a and each lower extension 45a is followed along the vertical direction H by a supporting element 6.

Also in the further embodiment of FIG. 5, an upper recess 29b produced by milling can be formed in each case on the end face 12b of the core plates 7 facing the coil carrier structure 4. In the example shown in FIG. 5, however, the adapter plate 32 is not used. In this upper recess 29b, a complementarily formed lower extension 45a engages, analogous to the example of FIG. 4, but—in contrast to the example of FIG. 4—does not project from the adapter plate 32, but from the coil carrier structure 4 in the opposite direction to the vertical direction H. A lower extension 45a of this kind can be provided for each core plate 7 on the coil carrier structure 4.

In the example shown in FIG. 5, an upper extension 45b projects from the coil carrier structure 4 on the upper side 46b, facing away from the core plates 7, of the coil carrier structure 4 for each holding-down element 25, which upper extension 45b is supported on the holding-down element 25 formed on the upper housing part 21a of the housing 21 and projecting away from it. As shown, an upper extension 45b is also provided for each lower extension 45a on the coil carrier structure 4, which are located opposite each other in the vertical direction H. In this further embodiment, it is also useful for the extensions 45a, 45b provided on the end face 12a and 12b to lie opposite each other, i.e. the recess 29a provided on the lower end face 12a follows in a virtual extension of the upper end face 12b along the vertical direction H. Accordingly, in the example of FIG. 5, each holding-down element 25 is followed along the vertical direction H by an upper extension 45b and each lower extension 45a is followed along the vertical direction H by a supporting element 6. The variant shown in FIG. 5 has a simpler design than that shown in FIG. 4 due to the absence of adapter plate 32 and is therefore also less expensive to manufacture.

FIG. 6 shows a further variant of the example in FIG. 3. In the example of FIG. 6, a lower and upper extension 30a, 30b projects from each of the two end faces 12a, 12b of the core plates 7 in the vertical direction H and opposite to the vertical direction H, with which the respective core plate 7 is supported on the coil carrier structure 4 and on the supporting elements 6 of the supporting structure 5. Similarly, in the example of FIG. 6, an upper extension 45b protrudes from the coil carrier structure 4 on the upper side 46b of the coil carrier structure 4 facing away from the core plates 7 for each holding-down element 25 and for each supporting element 6 in a manner analogous to the example of FIG. 5, which extension is supported on the holding-down element 25 formed on the housing 21 and protruding therefrom. As shown, a respective upper extension 30b faces a lower extension 30a along the vertical direction H.

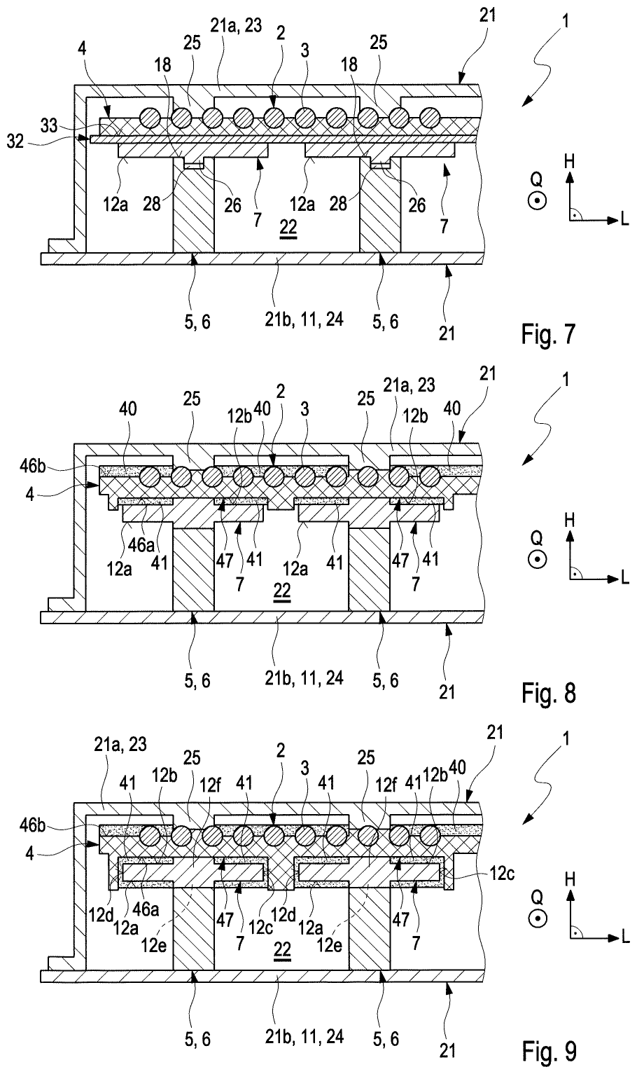

FIG. 7 shows a further development of the example according to FIG. 3. In this further embodiment, a positioning body 26 made of plastic is to be attached or adhesive-bonded to the end faces 12a of the core plates 7 facing the supporting structure 5, which positioning body 26 engages into a cutout 28 arranged on the upper side 18 of the respective supporting element 6, without touching the supporting element 6 in the vertical direction H. This supports precise lateral positioning of the core plate 7 relative to the supporting element 6 and thus to the other components of the induction charging device 1. Since the positioning bodies 26 are arranged at a distance from the respective supporting element 6 in the vertical direction H, it is ensured that the mechanical load path exists exclusively in the direct contact face between the core plate 7 and the supporting element 6 and that the positioning body 26 or after the assembly of the induction charging device 1 remains load-free.

FIG. 8 shows further embodiment, which, where appropriate, can be combined with each of the variants shown in FIGS. 3 through 7. In this case, a thermal filling material 40 is arranged on the upper side 46b of the coil carrier structure 4, facing away from the core plates 7. As shown, a thermal filling material 41 can also be arranged on the underside 46a of the coil carrier structure 4 facing away from the coil carrier structure 4, which filling material 41 is supported on the upper side of the core plates 7. This filling material 41 is therefore sandwiched between the core plates 7 and the coil carrier structure 4.

FIG. 9 shows a further development of the example in FIGS. 7 and 8. In the example of FIG. 9, the thermal filling material 41 is additionally arranged on the lower end face 12a of at least one, preferably two, of the peripheral faces 12c-12f, in contrast to the variant of FIG. 8.

As shown in FIGS. 8 and 9, cutouts 47 can be formed for the filling material 41 on the underside 46a of the coil carrier structure 4, in which cutouts 47 are arranged the filling material 41 and the respective core plate 7 on which upper end face 12b the filling material 41 is respectively arranged. A cutout 47 can therefore be provided for each core plate 7.

1. An induction charging device for an inductive vehicle charging system for charging a battery of a battery-powered electric vehicle, comprising:
at least one coil for generating an electromagnetic alternating field, which is formed by electrical conductors structured as strands, and a coil carrier structure composed of plastic for positioning the strands, in which the strands are at least partially embedded,
a supporting structure that is arranged below the at least one coil in a vertical direction of the induction charging device, the supporting structure has a plurality of supporting elements arranged at a distance from one another in a longitudinal direction perpendicular to the vertical direction and supported in the vertical direction on the coil carrier structure,
at least two magnetic field conducting core plates composed of a soft magnetic material for conducting magnetic flux, which are arranged at a distance from one another in each case along the longitudinal direction and each extend along the longitudinal direction and have at least one unground surface section, wherein the at least two core plates are supported in the vertical direction on at least one supporting element in each case.

2. The induction charging device according to claim 1, wherein the at least two of the core plates each have a parallelepipedal shape and each have two end faces extending perpendicular to the vertical direction and four peripheral faces,
wherein at least one of the faces has at least one unground face zone.

3. The induction charging device according to claim 1, wherein at least one face of the at least two core plates has at least one unground face zone that is a peripheral face.

4. The induction charging device according to claim 1, wherein at least one face of the at least two core plates has at least one unground face zone that is an end face.

5. The induction charging device according to claim 1, wherein at least one of face of the at least two core plates has two or more unground face zones, each of which is arranged at a distance from the others.

6. The induction charging device according to claim 1, wherein:
a housing is provided surrounding a housing interior, the housing has an upper and a lower housing part that lie opposite one another in the vertical direction,
the coil carrier structure, the at least two core plates and the supporting structure are arranged in the housing interior, wherein the supporting structure is supported on the lower housing part and the coil carrier structure is supported on the upper housing part.

7. The induction charging device according to claim 6, wherein a holding-down element that projects into the housing interior is arranged on the upper housing part for each supporting element, the holding-down element presses the coil carrier structure and the at least two_core plates against the supporting elements of the supporting structure.

8. The induction charging device according to claim 1, wherein in the vertical direction, a holding-down element and a supporting element are located opposite each other, so that a core plate and the coil carrier structure are arranged between the coil carrier structure and the supporting structure.

9. The induction charging device according to claim 1, wherein the coil carrier structure is either sandwiched between the supporting structure and an upper housing part or sandwiched between the guide plates and a upper housing part.

10. The induction charging device according to claim 1, wherein at least one core plate is supported on two adjacent supporting elements along the longitudinal direction.

11. The induction charging device according to claim 10, wherein at least one core plate is arranged in the longitudinal direction at a distance from the adjacent supporting elements, forming a respective gap.

12. The induction charging device according to claim 10, wherein at least one holding-down element is located opposite a supporting element in the vertical direction, so that the coil carrier structure is sandwiched between the holding-down element and the supporting element.

13. The induction charging device according to claim 1, wherein a step forming a bearing face is formed on the adjacent supporting elements, on which the respective core plate rests for support in the vertical direction.

14. The induction charging device according to claim 13, wherein the respective core plate rests in the vertical direction on the bearing face of the respective supporting element.

15. The induction charging device according to claim 1, wherein at least one core plate is connected to the respective supporting element in a substance-to-substance bond via at least two adhesive joints.

16. The induction charging device according to claim 1, wherein:
a positioning contour with at least one positioning element is formed on an end face of at least one core plate facing away from the coil carrier structure,
for each positioning element, a counter-positioning element complementary to this positioning element is formed on one of the bearing faces for laterally positioning the core plates relative to the supporting structure.

17. The induction charging device according to claim 16, wherein at least one positioning element is formed by a recess provided on the end face,
the recess is arranged on an outer rim section of the respective end face.

18. The induction charging device according to claim 1, wherein:
at least one core plate is supported on exactly one supporting element.

19. The induction charging device according to claim 18, wherein an end face facing the upper side of the supporting element of at least one core plate has a lower recess formed thereon in which the supporting element is partially accommodated, so that a floor of the lower recess rests on an upper side of the supporting element.

20. The induction charging device according to claim 18 wherein:
a positioning body is applied to an end face of at least one core plate facing the supporting structure, the positioning body engages in a cutout arranged on an upper side of the respective supporting element without touching the supporting element in the vertical direction.

21. The induction charging device according to claim 1, wherein the supporting elements are arranged on a base plate extending along the longitudinal direction, the base plate is arranged below the supporting structure with respect to the vertical direction.

22. The induction charging device according to claim 1, wherein an adapter plate is arranged between the coil carrier structure and the supporting structure with respect to the vertical direction, an upper side of the adapter plate resting flat against the coil carrier structure.

23. The induction charging device according to claim 1, wherein an upper recess is formed on an end face of at least one core plate facing the coil carrier structure, into which recess a complementary lower extension projecting from the coil carrier structure or from the adapter plate engages.

24. The induction charging device according to claim 1, wherein:
at least one upper extension projects from an upper side of the coil carrier structure facing away from the core plates and is supported on a holding-down element formed on a housing.

25. The induction charging device according to claim 1, wherein:
a lower extension projects from an end face facing away from the coil carrier structure of at least one core plate in the vertical direction, with which the core plate is supported on the supporting elements of the supporting structure adjacent in the vertical direction; or/and
an upper extension projects from an end faces of the at least one core plate facing the coil carrier structure in the vertical direction, with which projection the core plate is supported on the coil carrier structure.

26. The induction charging device according to claim 1, wherein:
a thermal filling material is arranged on a cover side facing the coil carrier structure of at least one core plate; or/and
a thermal filling material is arranged on a cover side facing away from the coil carrier structure of at least one core plate.

27. The induction charging device according to claim 1, wherein a thermal filling material is arranged on at least one peripheral face of at least one core plate.

28. An inductive vehicle charging system for charging a battery of a battery-powered electric vehicle, comprising:
a stationary induction charging device that is placed on a floor surface,
a mobile induction charging device that is located in or on the vehicle,
wherein the stationary induction charging device and/or the mobile induction charging device is an induction charging device according to claim 1.
